(19) United States
(12) Patent Application Publication
(10) Pub. No.: US 2005/0101246 A1
(43) Pub. Date: May 12, 2005

(54) MPEG2 SPTS-splitting type subscriber distribution system and distribution method thereof

(76) Inventors: Do-In Choi, Seoul (KR); Yun-Je Oh, Yongin-shi (KR); Jun-Ho Koh, Suwon-shi (KR)

Correspondence Address: CHA & REITER, LLC, 210 ROUTE 4 EAST STE 103, PARAMUS, NJ, 07652, US

(21) Appl. No.: 10/706,494

(22) Filed: Nov. 12, 2003

(30) Foreign Application Priority Data
Nov. 6, 2003 (KR) 2003-37562

(51) Int. Cl. H04H 1/00

(52) U.S. Cl. 455/3.01; 455/414.4

(57) ABSTRACT

A subscriber distribution system for distributing broadcasting data to subscribers through a subscriber network. The subscriber distribution system has a PID filter section for checking contents of an inputted MPEG2 MPTS frame and splitting the MPEG2 MPTS frame into SPTS, a table regenerator for regenerating a PAT and a PMT that correspond with the SPTS by changing contents in the PAT and the PMT. An SPTS splitting and storing section stores the SPTS at high speed in a memory area of a buffer, which is assigned to subscribers according to PIDS. A subscriber distribution section selecting the SPTS requested by subscribers and storing the SPTS in the memory area of the buffer assigned to subscribers. A control section receives MPTS information from a higher network to provide MPTS information to the PID filter section and the table regenerator, and receives a request for a program from subscribers, and transfers the request to the subscriber distribution section.

### CLAIM OF PRIORITY

This application claims priority to an application entitled “MPEG2 SPTS-splitting type subscriber distribution system and distribution method thereof,” filed in the Korean Intellectual Property Office on Jun. 11, 2003 and assigned Ser. No. 2003-37562, the contents of which are hereby incorporated by reference.

### BACKGROUND OF THE INVENTION

1. Field of the Invention

The present invention relates to a subscriber distribution system for providing a broadcasting service to subscribers through a subscriber network. More particularly, the present invention relates to MPEG 2 splitting type subscriber distribution.

2. Description of the Related Art

There are a number of studies being conducted at the present time regarding subscriber networks. Interest in subscriber networks has increased as the demand for broadband multimedia including the Internet increased. Accordingly, a subscriber network for a digital broadcasting service has been developed to provide a broadband multimedia service to subscribers.

The subscriber network generally uses an ATM (asynchronous transfer mode) technique to provide the broadband multimedia service to subscribers. However, this ATM technique necessarily requires an expensive ATM switch that is contrary to the user's demand for an inexpensive subscriber network.

As an alternative to an ATM network another type of subscriber network that can be achieved at a relatively low cost that uses the Ethernet. However, a subscriber network using the Ethernet generally has an inferior QoS (quality of service) with respect to broadcasting data. Therefore, in order to provide a subscriber network at a low cost while ensuring superior QoS with respect to broadcasting data, an Ethernet-based TDM (time division multiplexing) technique is used.

FIG. 1 is a block view showing an example of conventional TDM-type transmission methods in a subscriber network, which is capable of providing superior QoS. Referring to FIG. 1, broadcasting data are transmitted from an OLT (optical line terminal) to an ONU (optical network unit) by formatting various broadcasting channels into M PTS (multiple program transport streams) to match with a cable network. Upon receiving the MPTS from the OLT, a subscriber distribution system of the ONU transmits the MPTS to a cross point switch 4 through a serializer 2. The cross point switch 4 switches at least two MPEG2 TS (transport streams), which are requested by a customer premise network, into a TDM module 8 according to a subscriber's program stored in a control section 6. Then, the TMD module 8 provides the MPEG2 TS transmitted from the cross point switch 4 to subscribers by binding at least two MPEG2 TS to form one stream. That is, a conventional subscriber distribution system branches a serial MPEG2 TS (transport stream) into two transport streams, selects a TS containing a program required by a subscriber by using two cross point switches 4, and binds two transport streams into one stream in the TDM module. The ONU transmits two programs to the subscriber requesting the programs through the above-mentioned processes.

According to the above conventional TDM-type transmission method that uses two transport streams requested by the subscriber to be transmitted using the cross point switch, a size of a video screen exposed to one subscriber is mechanically fixed corresponding to the number of subscriber ports in the cross point switch and the number of predetermined input streams of the TDM module.

Therefore, there is a problem in that not only is a data transmission rate of the TDM module fixed, but a system is also required to be exchanged if the subscriber requests at least two video streams, so that it is impossible to flexibly manage the system.

In addition, in order to improve data transmission efficiency when transmitting broadcasting data, several transport streams containing various programs are bound to form one transport stream in a higher level network, thereby creating an MPTS (multi program transport stream).

However, if the MPTS is directly transmitted by switching the MPTS at a subscriber terminal, unnecessary programs, which are not requested by the subscriber, may be transmitted together with programs requested by the subscriber, thereby resulting in a waste of bandwidth and an increasing cost of optical components when forming an FTTH (fiber to the home). In addition, when it is combined with a transmission technique, such as xDSL, a problem occurs when transmitting data due to a band limitation.

### SUMMARY OF THE INVENTION

Accordingly, the present invention has been in light of the above-mentioned problems occurring in the prior art. An object of the present invention is to provide a subscriber distribution system and a distribution method thereof, that transmits MPTS (multiple program transport steams) by splitting the TS (transport streams) into SPTS (single program transport stream) units having a predetermined bit rate, instead of directly transmitting MPTS created in a higher network to subscribers.

Another object of the present invention is to provide a subscriber distribution system and a distribution method capable of effectively transmitting a plurality of programs requested by subscribers as compared with a conventional TDM method. This object is achieved in part by buffering the TS transmitted to the subscribers, thereby achieving an inexpensive network, with the added advantage of not require the use of expensive REMUX equipment for receiving ground waves and signals from a DMC (digital media center) and a satellite.

In order to accomplish the above objects, the present invention provides a subscriber distribution system that distributes broadcasting data to subscribers through an subscriber network, wherein the subscriber distribution system comprises: a PID filter section for checking contents of an inputted MPEG2 MPTS frame and splitting the MPEG2 MPTS frame into SPTS; a table regenerator for regenerating a PAT and a PMT that corresponds with the SPTS by changing contents in the PAT and the PMT; an SPTS splitting and storing section for storing the SPTS at high speed in a memory area of a buffer, which is assigned to subscribers according to PIDs; a subscriber distribution section selecting the SPTS requested by subscribers and storing the SPTS in the memory area of the buffer assigned to subscribers; and a control section receiving MPTS information from a higher network to provide MPTS information to the PID filter section and the table regenerator, receiving a request for a program from subscribers, and transferring the request to the subscriber distribution section.

According to another aspect of the present invention, there is provided a method for distributing broadcasting data to subscribers through an subscriber network, the method comprising the steps of: receiving an MPEG2 MPTS from a higher network and splitting an MPTS frame into SPTS according to PID obtained through MPTS information and MPTS table information; regenerating a PAT and a PMT in correspondence with the SPTS by changing contents of the PAT and the PMT; storing at least one SPTS corresponding to each subscriber as subscribers request a program; and transmitting stored broadcasting data to each subscriber.

### BRIEF DESCRIPTION OF THE DRAWINGS

The above objects and other features and advantages of the present invention will be more apparent from the following detailed description taken in conjunction with the accompanying drawings, in which:

FIG. 1 is a view showing a conventional transmission method in a subscriber network by using a TDM technique;

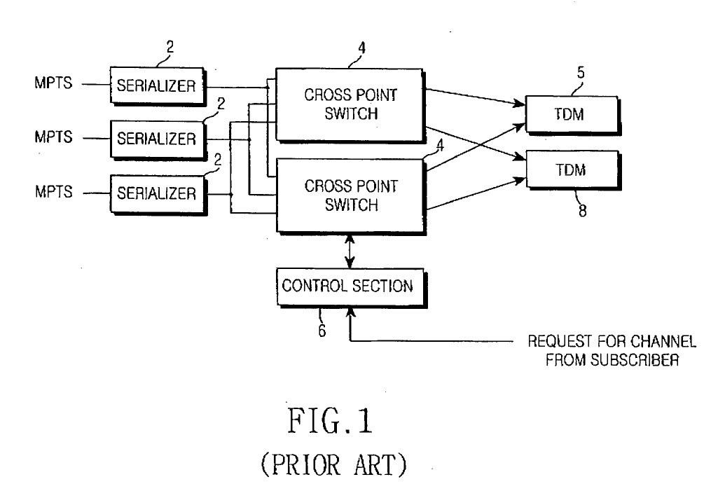

FIG. 2 shows a structure of a subscriber distribution system according to one embodiment of the present invention;

FIG. 3 shows SPTS splitting and storing processes and a table regenerating process in a subscriber distribution system, and an SPTS structure thereof according to one embodiment of the present invention; and

FIG. 4 blocks shows a method for processing digital broadcasting data in a subscriber distribution system according to one embodiment of the present invention.

### DETAILED DESCRIPTION OF THE PREFERRED EMBODIMENT

The following description in conjunction with the drawings are presented for purposes of illustration and not as a means of limitation, as the artisan will appreciate there are various changes that can be made which lie within the spirit of the invention and the scope of the appended claims.

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

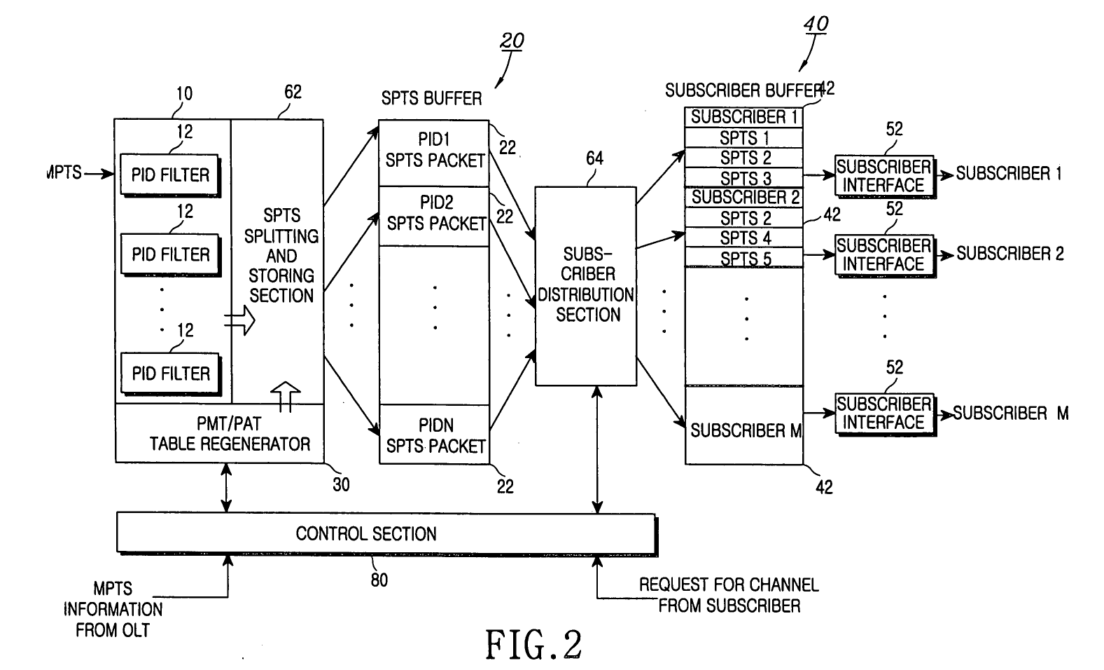

FIG. 2 is a view showing a structure of a subscriber distribution system according to one embodiment of the present invention.

Referring to FIG. 2, the subscriber distribution system of the present invention includes a PID (program ID) filter section 10 for splitting an MPTS (multiple program transport stream) into a plurality of SPTS (single program transport streams) after checking an MPTS frame inputted therein through an interface, a table regenerator 30 for changing contents of a PAT (program a llocation table) and a PMT (program map table) when the MPTS is split into SPTS, an SPTS splitting and storing section 62 capable of storing broadcasting data, which is filtered through the PID filter section 10, into a predetermined pointer assigned according to a PID at high speed, a subscriber distribution section 64 selecting the SPTS required by a subscriber and storing the SPTS in a memory area assigned to the subscriber, a subscriber interface 52 for converting broadcasting data into a stream such that the stream can be transferred into the subscriber, and a control section 80 receiving a program selected by a user through a CCP (channel change protocol) and receives MPTS information from a higher network to process the MPTS.

Next, the operation of the subscriber distribution system of the present invention will be described herein below.

The MPTS is input into the PID filter section 10 of the subscriber distribution system from the higher network. At this time, the control section 80 receives MPTS information including PCR (program clock recovery), PIDs, and a PSI (program specific information) table from the higher network (i.e. from an OLT), and sends MPTS information to the PD filter section 10 and the table regenerator 30.

The PID filter section 10 checks the PID of each packet of the MPTS and splits the PAT, PMT and MPEG data. The PID is an identifier for digital broadcasting channels. A one to one correspondence is used between the number of SPTSs and the number of PID filters required. For example, the PID identifies various channels, such as KBS1, KBS2 and EBS provided from the Korea broadcasting system. If the MPTS includes ten SPTS, ten PID filters are required. According to the preferred embodiment of the present invention, a PID filter section and a processing section can be separately provided for a PID representing the PMT and PAT.

In addition, the table regenerator 30 changes contents of the PAT and the PMT with respect to the MPTS when the MPTS is split into the SPTS. In other words, when the MPTS including various program data is split into SPTS including single program data, program information of the PAT and the PMT is changed.

Accordingly, the table regenerator 30 regenerates the PAT and the PMT to match with the SPTS. To this end, PMT and PAT packets split from the MPTS must be treated separated from general MPEG data. The table regenerator 30 can obtain-PID information of each SPTS with reference to table information of the MPTS or when the MPTS is created in the higher network. According to the preferred embodiment of the present invention, the subscriber distribution system is installed in a network and MPTS information is transmitted to the subscriber distribution system from the higher network.

On the other hand, broadcasting data filtered through the PID filter section 10 are sent to the SPTS splitting and storing section 62 and stored at high speed in pointers of an SPTS buffer 20, which are assigned according to the PID. At this time, the SPTS splitting and storing section 62 stores broadcasting data, which are PID-filtered by using a DMA (direct memory access) technique, in the SPTS buffer 20.

The SPTS splitting and storing section 62 must store PID-filtered broadcasting data in the SPTS buffer 20 at high speed in order to minimize a delay of broadcasting data, so the DMA technique is adopted. As is well known in the arts, when adopting the DMA technique, information can be transmitted without providing a predetermined control section. That is, the SPTS splitting and storing section 62 has a role of a DMA controller so that the SPTS splitting and storing section 62 reads broadcasting data filtered through the PID filter section 10 and stores broadcasting data in the pointers, which are assigned in the SPTS buffer 20 according to PIDs. At this time, data access speed must be faster than a maximum bit rate of each SPTS.SPTS data stored in the SPTS buffer 20 are transmitted to each subscriber area of a subscriber buffer 40 by means of the subscriber distribution section 64. The control section 80 receives program information requested by the subscriber through the CCP and notifies it to the subscriber distribution section 64. The subscriber distribution section 64 receives programs requested by the subscriber through the control section 80 and provides SPTS corresponding to channels selected by the subscriber to the subscriber buffer 40. In addition, the subscriber distribution section 64 selects the SPTS required by the subscriber and stores SPTS in a memory area of the subscriber buffer 40.

In the same manner as the SPTS splitting and storing section 62, the subscriber distribution section 64 adopts the DMA technique for high-speed access. In other words, in order to store the SPTS in each memory area 42 of the subscriber buffer 40, the subscriber distribution section 64 moves into the pointer of a corresponding memory area of the SPTS buffer 20 and extracts data. As mentioned above, the subscriber buffer 40 stores SPTS broadcasting data, which corresponds to a channel requested by the subscriber, in the memory area 42 assigned to the subscriber. Memory areas of the subscriber can be flexibly managed by a manager according to requests of the subscriber. Accordingly, if a certain subscriber wishes to view a plurality of programs, enough memory areas need to be assigned to the subscriber in such a manner that various SPTS data can be buffered. However, as the quantity of SPTS that can be transmitted depends on the transmission speed of the subscriber interface, the memory areas must be assigned to the subscriber within the limits of transmission capacity.

In addition, the subscriber interface 52 converts SPTS broadcasting data into a stream to be transmitted into the subscriber.

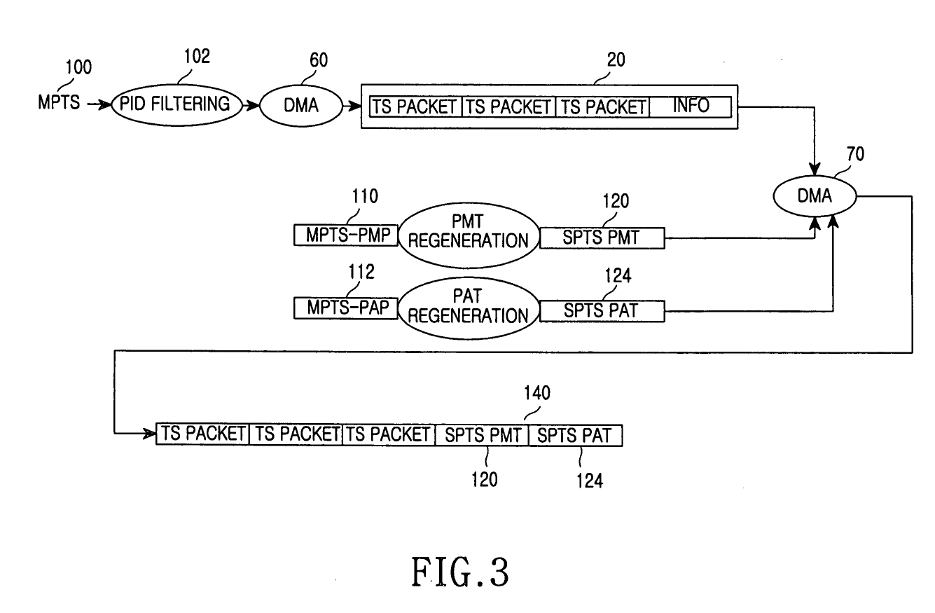

FIG. 3 is a view showing SPTS splitting and storing processes, a table regenerating process, and an SPTS structure for performing the processes.

Referring to FIG. 3, an MTPS 100 transmitted from an OLT is split into the SPTS through a PID filtering 102. MPEG data is splitable by allowing the control section 80 to apply PID information transmitted from the higher network through an NMS (network management system) to the PID filter section 10.

For example, a 188-byte TS packet stores a PID value next to SYNC byte called 0×47 (HEX), and the PID filter section 10 compares the PID value with a predetermined PID value stored in the control section to split packets having the PID value in match with the predetermined PID value. The split SPTS is stored in the SPTS buffer 20 by means of a DMA 60 of the SPTS splitting and storing section 62. At this time, the PMT 110 and the PAT 112 adapted for the MPTS are regenerated as new PMT 120 and PAT 122 adapted for the SPTS by means of the table regenerator 30. In addition, the regenerated PMT 120 and PAT 122 are added to SPTS broadcasting data through a DMA 70 by means of the subscriber distribution section 64.

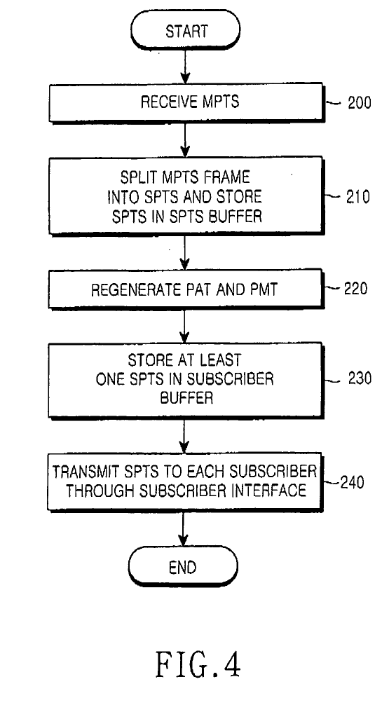

FIG. 4 is a block view showing a method for processing digital broadcasting data in the subscriber distribution system according to one embodiment of the present invention.

Referring to FIGS. 2 to 4, the subscriber distribution system receives the MPTS from the higher network (step 200). Then, the subscriber distribution system splits the MPTS frame into the SPTS according to the PID, which is obtained based on MPTS information and MPTS table information transmitted from the OLT (step 210) and stores the SPTS in the SPTS buffer.

Then, the subscriber distribution system regenerates the PMT and the PAT for the SPTS stored in the SPTS buffer (step 220). As described above, when the MPTS including various program data is split into SPTS units including single program data, program information of the PAT and the PMT is changed. Thus, the table regenerator of the subscriber distribution system regenerates both the PMT and the PAT adapted for the SPTS.

Subsequently, the subscriber distribution system stores at least one SPTS in each subscriber buffer as subscribers request programs (step 230). At this time, the request from each subscriber is received in the subscriber distribution system through the CCP (channel change protocol). The stored SPTS corresponding to the program requested by the subscribers is transmitted into each subscriber through the subscriber interface by means of the subscriber distribution system (step 240).

According to the present invention, a switching structure is formed based on SPTS units requested by the subscriber instead of MPTS units, so a transport network can be efficiently established. In addition, since it is possible to lower a transmission bit rate, optical devices and RF devices can be installed in a transmitter or a receiver at a low cost and burden of the subscriber can be relatively reduced. Thus, broadcasting data can be efficiently transmitted even in a system having limited transmission capacity, such as VDSL.

One advantage of the present invention is that expensive equipment, such as REMUS, is not required to form an independent network for the MPTS of different bit rate derived from the DMC (digital media center), the satellite, and ground waves. The subscriber distribution system can spilt the SPTS and perform a function of the REMUX, so the independent network can be established at a relatively low cost.

While the invention has been shown and described with reference to certain preferred embodiments thereof, it will be understood by those skilled in the art that various changes in form and details may be made therein without departing from the spirit and scope of the invention as defined by the appended claims.

1. A subscriber distribution system for distributing broadcasting data to subscribers through an subscriber network, the subscriber distribution system comprising:
a program id (PID) filter section for checking contents of an inputted MPEG2 multiple program transport streams (MPTS) frame and splitting the MPEG2 MPTS frame into a plurality of single program transport streams (SPTS);
a table regenerator for regenerating a program allocation table (PAT) and a program map table (PMT) that corresponds with the SPTS by changing contents in the PAT and the PMT;
an SPTS splitting and storing section for storing the SPTS at high speed in a memory area of a buffer, which is assigned to subscribers according to PIDs;
a subscriber distribution section for selecting the SPTS requested by subscribers and storing the SPTS in the memory area of the buffer assigned to subscribers; and
a control section receiving MPTS information from a higher network to provide MPTS information to the PID filter section and the table regenerator, receiving a request for a program from subscribers, and transferring the request to the subscriber distribution section.

2. The subscriber distribution system as claimed in claim 1, wherein a quantity of filters in the PID filter section corresponds to a quantity of SPTSs that the MPTS has been split into.

3. The subscriber distribution system as claimed in claim 1, wherein the control section receives program information requested by subscribers through a channel change protocol (CCP).

4. The subscriber distribution system as claimed in claim 1, wherein the SPTS splitting and storing section and the subscriber distribution section adopt a direct memory access (DMA) technique.

5. The subscriber distribution system as claimed in claim 1, wherein the PID filter section includes at least one PID filter for filtering a plurality of PIDs contained in the MPEG2 MPTS.

6. The subscriber distribution system as claimed in claim 1, further comprising a subscriber interface for converting the SPTS stored that match with each subscriber into a stream to transmit the SPTS to each subscriber.

7. A method for distributing broadcasting data to subscribers through a subscriber network, the method comprising the steps of:
receiving an MPEG2 multiple program transport streams (MPTS) from a higher network and splitting an MPTS frame into a plurality of single program transport streams (SPTS) according to program identification (PID) obtained through MPTS information and MPTS table information;
regenerating a program allocation table (PAT) and a program mapping table (PMT) that corresponds with the SPTS by changing contents of the PAT and the PMT;
storing at least one SPTS corresponding to each subscriber as subscribers request a program; and
transmitting stored broadcasting data to each subscriber.

8. The method as claimed in claim 7, wherein a request for a program from subscribers is received through a channel change protocol (CCP).

9. The method as claimed in claim 7, further comprising the step of providing a one-to-one correspondence between a number of SPTSs and the number of PID filters required.
